(19) United States
(12) Patent Application Publication
(10) Pub. No.: US 2025/0388463 A1
(43) Pub. Date: Dec. 25, 2025

(54) POROUS MAGNESIUM STRUCTURE FOR STORING HYDROGEN, METHOD FOR MANUFACTURING SAME, AND METHOD FOR STORING HYDROGEN

(71) Applicants: KOREA ADVANCED INSTITUTE OF SCIENCE AND TECHNOLOGY, Daejeon (KR); SAUDI ARABIAN OIL COMPANY, Dhahran (SA)

(72) Inventors: Eun Seon CHO, Daejeon (KR); Yong Jun CHO, Daejeon (KR); Aqil JAMAL, Dhahran (SA)

(21) Appl. No.: 18/880,521

(22) PCT Filed: Oct. 4, 2023
(86) PCT No.: PCT/KR2023/015204

§ 371 Date: Dec. 31, 2024

(30) Foreign Application Priority Data
Nov. 4, 2022 (KR) 10-2022-0146172
Sep. 12, 2023 (KR) 10-2023-0121330

(51) Int. Cl. C01B 3/00; C22C 1/08; C22C 23/00

(52) U.S. Cl. CPC C01B 3/0026; C22C 1/088; C22C 23/00

(57) ABSTRACT

A porous magnesium structure for storing hydrogen comprising a magnesium skeleton and pores, having a three-dimensional porous structure, wherein the average thickness of the magnesium skeleton is greater than 0 nm and less than or equal to 200 nm, a method of preparing same, and a method of storing hydrogen, are provided.

### TECHNICAL FIELD

The present invention relates to a porous magnesium structure for storing hydrogen, a method of preparing the same, and a method of storing hydrogen.

### RELATED ART

Current commercialized hydrogen storage methods are physical storage methods that compress hydrogen at high pressure or store it at ultra-low temperatures. However, physical hydrogen storage suffers from large energy losses during the storage process, low bulk storage density, and the use of expensive carbon fibers.

To solve these problems, metal hydrides or complex hydrides have been widely studied as solid hydrogen storage materials with high energy density and high safety, but they have the disadvantage that the required temperature for hydrogen absorption/desorption is too high or the absorption/desorption rate is too slow.

### DETAILED DESCRIPTION OF THE INVENTION

### Technical Problem

One example provides a porous magnesium structure for storing hydrogen that allows rapid absorption and desorption of hydrogen at low temperatures.

Another example provides an environmentally friendly and simple method of manufacturing the porous magnesium structure for storing hydrogen.

Another example provides a method of storing hydrogen using a porous magnesium structure for storing hydrogen.

### Technical Solution

According to one example, there is provided a porous magnesium structure for storing hydrogen comprising a magnesium skeleton and pores, having a three-dimensional porous structure, wherein the magnesium skeleton has an average thickness of greater than 0 nm and less than or equal to 50 nm.

The magnesium skeleton may comprise a magnesium body and an oxide film located on a surface of the magnesium body.

The oxide film may comprise a magnesium oxide, wherein the magnesium oxide may comprise MgO.

The magnesium body and the oxide film may have a molar ratio of 1:1 to 1:5.

The average diameter of the pores may be 35 nm to 65 nm.

The specific surface area of the porous magnesium structure may be 20 m²/g to 40 m²/g.

The porous magnesium structure may have a diffraction peak at 20 of 35° to 40° in the XRD pattern.

A transition metal located on the surface of the magnesium skeleton may be further comprised, wherein the transition metal may comprise a metal having a higher standard reduction potential than magnesium.

Another example provides a method of preparing a porous magnesium structure for storing hydrogen comprising the step of dealloying a magnesium-alkali metal alloy by placing it in a solution to prepare a porous magnesium structure comprising a magnesium skeleton and pores, wherein the solution comprises an aromatic compound dissolved in an organic solvent.

The aromatic compound may include naphthalene, biphenyl, phenanthrene, anthracene, or combinations thereof.

The dealloying may be the dissolution of the alkali metal from the magnesium-alkali metal alloy.

The dissolved alkali metal may react with aromatic compounds in the solution to form by-products.

The method may further comprise, after the step of manufacturing the porous magnesium structure, the step of mixing the manufactured porous magnesium structure with a transition metal-containing precursor to manufacture a porous magnesium structure further comprising a transition metal.

The transition metal-containing precursor may comprise a chloride of the transition metal, a complex of the transition metal, or a combination thereof.

The transition metal-containing precursor may be mixed in an amount of 1 part to 10 parts by weight per 100 parts by weight of the porous magnesium structure prepared above.

The porous magnesium structure further comprising the transition metal may have the transition metal located on a surface of the magnesium skeleton.

According to another example, there is provided a method of storing hydrogen comprising the steps of: absorbing hydrogen gas into a porous magnesium structure for storing hydrogen to obtain magnesium hydride; and reversibly desorbing hydrogen gas from the magnesium hydride.

The absorption may be carried out at a temperature of 150° C. to 200° C.

The desorption may be performed at a temperature of 250° C. to 300° C.

### Advantageous Effects

The porous magnesium structure for storing hydrogen according to one example can be useful as a hydrogen storage material because it can absorb and desorb hydrogen at low temperatures and at high rates. Furthermore, the porous magnesium structure for storing hydrogen is environmentally friendly and can be manufactured in a simple way, thus contributing to the acceleration of the advent of the hydrogen economy.

### BRIEF DESCRIPTION OF DRAWING

FIG. 1 is a schematic illustration of a porous magnesium structure for storing hydrogen, according to one example.

FIG. 2 is a schematic diagram illustrating a method of preparing a porous magnesium structure for storing hydrogen, according to one example.

FIG. 3 is an SEM image of a porous magnesium structure for storing hydrogen according to Example 1.

FIG. 4A is an SEM image of a porous magnesium structure for storing hydrogen according to Example 1, and FIG. 4B is an SEM image of a porous magnesium structure for storing hydrogen according to Comparative Example 1.

FIG. 5 is an XRD analysis graph of a porous magnesium structure for storing hydrogen according to Example 1 and Comparative Example 1.

FIG. 6A is an N₂ adsorption curve of a porous magnesium structure for storing hydrogen according to Example 1, FIG. 6B is a pore size distribution curve of a porous magnesium structure for storing hydrogen according to Example 1, and FIG. 6C is a BET analysis graph of a porous magnesium structure for storing hydrogen according to Example 1.

FIG. 7A is an XPS analysis graph of a porous magnesium structure for storing hydrogen according to Example 1, and FIG. 7B is an XPS analysis graph of a porous magnesium structure for storing hydrogen according to Comparative Example 1.

FIG. 8A is a hydrogen absorption curve of a porous magnesium structure for storing hydrogen according to Example 1 and Comparative Example 1, and FIG. 8B is a hydrogen desorption curve of a porous magnesium structure for storing hydrogen according to Example 1 and Comparative Example 1.

### BEST MODE

Unless otherwise defined, all technical and scientific terms used herein have the same meaning as commonly understood by a person skilled in the art. In general, the nomenclature and experimental methods used herein are well known and in common use in the art.

Hereinafter, with reference to the drawings attached hereto, various examples of the present invention will be described in detail to facilitate practice by one having ordinary skill in the art. The present invention may be implemented in various different forms and is not limited to the examples described herein.

In order to clearly illustrate the present invention, matters not relevant to the description have been omitted, and identical or similar components are designated by the same reference numerals throughout the specification.

Further, the size and thickness of each configuration shown in the drawings is arbitrarily indicated for ease of illustration and the present invention is not necessarily limited to that shown. In the drawings, the thicknesses have been enlarged for clear expression of various layers and areas, and in the drawings, the thicknesses of some layers and areas have been exaggerated for ease of illustration.

Also, when a layer, membrane, region, plate, etc. is “above” or “on” another part, this includes not only when it is “directly above” another part, but also when there is another part therebetween. Conversely, when a part is “directly above” another part, it means that there is no other part therebetween. Also, being “above” or “on” a reference means being above or below the reference, and does not necessarily mean being “above” or “on” the reference in the opposite direction of gravity.

Also, throughout the specification, when a part “includes” a component, it means that it may further include other components, not exclude other components, unless specifically noted to the contrary.

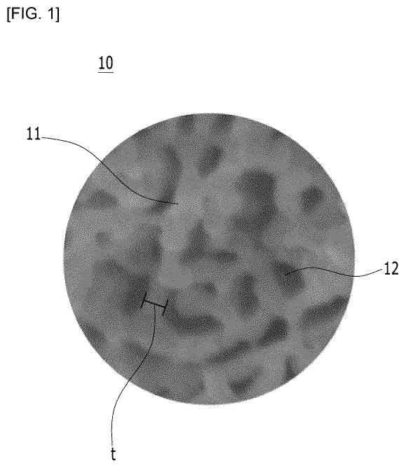

A porous magnesium structure for storing hydrogen, according to one example, is described with reference to FIG. 1.

FIG. 1 is a schematic illustration of a porous magnesium structure for storing hydrogen, according to one example.

Referring to FIG. 1, the porous magnesium structure 10 for storing hydrogen according to one example has a three-dimensional porous structure, comprising a magnesium skeleton 11 and pores 12. The magnesium skeleton 11 has an average thickness (t) of greater than 0 nm and less than or equal to 50 nm.

In the porous magnesium structure 10 for storing hydrogen according to one example, hydrogen gas diffuses rapidly into the interior through the pores 12, dissociates from the surface of the magnesium skeleton 11 and diffuses into the interior of the magnesium lattice in the form of hydrogen atoms. Thus, due to the short diffusion distance of the nanostructured magnesium skeleton 11, i.e., whose crystalline is nanostructured, the absorption or desorption of hydrogen can rapidly occur at a low temperature. Furthermore, since the porous magnesium structure 10 is manufactured by nanostructuring magnesium itself without using other composite materials, as in the manufacturing method described later, it has a high energy density.

The average thickness (t) of the magnesium skeleton 11 may be greater than 0 nm and less than or equal to 50 nm or less, such as 1 nm to 50 nm, 1 nm to 45 nm, 1 nm to 40 nm, 5 nm to 35 nm, or 5 nm to 30 nm. When the magnesium skeleton 11 has an average thickness (t) within the above range, the diffusion distance of the hydrogen atoms in the lattice is reduced during the absorption or desorption of hydrogen, and hydrogen gas is also smoothly diffused through the pores, so that the absorption and desorption of hydrogen can occur at a high speed.

The magnesium skeleton 11 may comprise a magnesium body and an oxide film located on a surface of the magnesium body.

The oxide film may comprise a magnesium oxide. The magnesium oxide may include MgO, Mg(OH)₂, or a combination thereof.

The magnesium body and the oxide film may have a molar ratio of 1:1 to 1:5, such as a molar ratio of 1:1 to 1:4. The molar ratio may be measured in a region near the surface of the magnesium skeleton, more particularly in a region having a depth from the surface of the magnesium skeleton to the interior of 1 nm to 10 nm. When the molar ratio of the magnesium body and the oxide film is within the above range, a well-nanostructured magnesium skeleton having a thin oxide film can be obtained with a metallic surface that is very advantageous for storing hydrogen. As a result, a porous magnesium structure can be obtained in which the absorption and desorption of hydrogen proceeds at a fast rate at low temperatures.

The average diameter of the pores 12 may be 35 nm to 65 nm, such as 40 nm to 60 nm. When the average diameter of the pores is within the above range, due to the short diffusion distance of the nanostructured magnesium skeleton 11, the absorption and desorption of hydrogen can occur at a high rate and at a low temperature. Here, the average diameter of the pores refers to the diameter of the long axis of the pores.

The specific surface area of the porous magnesium structure 10 may range 20m²/g to 40 m²/g, such as 20 m²/g to 30 m²/g. When the specific surface area of the porous magnesium structure 10 is within the above range, more magnesium can be exposed to the hydrogen gas phase, allowing the absorption and desorption of hydrogen at high rates and low temperatures, which can be useful as a hydrogen storage material.

The porous magnesium structure 10 may have a diffraction peak at 20 of 35° to 40°, such as 20 of 36° to 39°, in an X-ray diffraction (XRD) pattern. This characteristic of the XRD pattern indicates that the porous magnesium structure 10 is made of pure magnesium containing very few impurities. If the porous magnesium structure 10 has the above XRD pattern, it can absorb and desorb hydrogen at a fast rate and at a low temperature, which can be useful as a hydrogen storage material.

The porous magnesium structure 10 may further comprise transition metals located on the surface of the magnesium skeleton 11.

Since the transition metals can act as catalysts in the absorption and desorption reactions of hydrogen, their introduction within the porous magnesium structure 10 allows the absorption and desorption of hydrogen at a faster rate. Furthermore, since the porous magnesium structure according to one example is manufactured in a non-corrosive reaction environment, as described later, such an environment facilitates the introduction of the transition metal acting as a catalyst within the porous magnesium structure 10 because it has a metallic magnesium surface that is favorable for the introduction of the transition metal.

The transition metal can be any metal with a higher standard reduction potential than magnesium. Examples include, but are not limited to, Ni, Ti, Co, or any combination thereof.

In the following, a method of manufacturing the porous magnesium structure 10 described above will be described.

The porous magnesium structure 10 according to one example is manufactured in a non-corrosive solution phase, specifically by dealloying a magnesium-alkali metal alloy by placing it in a solution. In this case, the solution is an aromatic compound dissolved in an organic solvent.

Dealloying means that the alkali metal is selectively dissolved from the magnesium-alkali metal alloy, and the remaining magnesium atoms grow into a porous magnesium structure 10 consisting of a magnesium skeleton 11 with a nanoscale size, i.e., with a nanometer thickness, through a self-assembly process, and pores 12 with a nanometer diameter.

Conventional methods for forming porous metals are mainly based on dealloying them from alloys using corrosive, strong acids, and mainly used for precious or transition metals. The use of corrosive materials is not only environmentally unfriendly, but also not applicable to elements with a high oxidation tendency, such as magnesium. Magnesium is an element that is susceptible to oxidation, and oxidation or deactivation of the magnesium surface adversely affects the hydrogen storage performance of magnesium, so it is important to minimize this to manufacture a porous magnesium structure. If the porous magnesium structure is dealloyed by using corrosive strong acids or by dissolving lithium from the oxidation electrode, the surface of the magnesium is greatly oxidized due to the susceptibility of magnesium to oxidation, which reduces the hydrogen storage performance.

In one example, a porous metal structure has been successfully synthesized from magnesium by performing the synthesis in a non-corrosive solution phase, unlike conventional porous metal synthesis methods. According to one example, the porous magnesium structure 10 is prepared by dealloying in a reductive reaction environment in a non-corrosive solution. It is manufactured without the need for corrosive materials or electrochemical equipment typically used to produce dealloying, and thus can be fabricated in an environmentally friendly and simple process, which can contribute to the acceleration of the advent of the hydrogen economy.

Furthermore, the transition metals that catalyze the absorption and desorption reactions of hydrogen cannot be introduced in a corrosive environment, whereas in a reductive reaction environment in a non-corrosive solution according to one example, the transition metals are not leached, so that the transition metals can be introduced in the porous magnesium structure 10 in the same process without additional processing. Thus, the porous magnesium structure 10 into which the transition metal is introduced can further accelerate the absorption and desorption of hydrogen.

In the case of a magnesium-alkali metal alloy used as a raw material, the alkali metal may be, for example, but not limited to, Li, Na, K, etc.

In a solution in which the aromatic compound is dissolved in an organic solvent, the aromatic compound may be, for example, a compound having two or more aromatic rings. Specifically, the aromatic compound may include, for example, but is not limited to, naphthalene, biphenyl, phenanthrene, anthracene, or combinations thereof.

In a solution in which the aromatic compound is dissolved in an organic solvent, the organic solvent may be any solvent capable of dissolving the aromatic compound, without limitation. Examples of organic solvents include tetrahydrofuran (THF), diethylether, hexamethylphosphoramide (HMPA), and 1,2-dimethoxyethane.

The alkali metal dissolved by dealloying may react with aromatic compounds in the solution to form by-products. The by-product formed can serve as a reducing agent to protect the porous magnesium structure 10 from oxidation. Furthermore, the by-product can be further utilized in processes such as the synthesis of nanoparticles as a reducing agent.

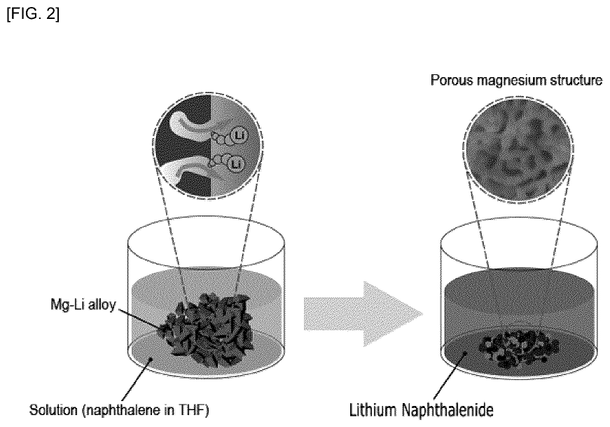

As an example, a method of manufacturing a porous magnesium structure 10 according to one example will be described with reference to FIG. 2. While FIG. 2 is illustrative for purposes of explanation, the method of manufacturing a porous magnesium structure according to one example is not limited thereto.

FIG. 2 is a schematic diagram illustrating a method of preparing a porous magnesium structure for storing hydrogen, according to one example.

Referring to FIG. 2, the porous magnesium structure 10 according to one example can be prepared by dealloying a magnesium-lithium alloy processed in the form of 1 mm to 5 mm chunks by placing it in a solution of naphthalene dissolved in THF solvent. Specifically, only the lithium inside the crystals of the magnesium-lithium alloy is selectively dissolved, and the remaining magnesium atoms grow into nanosized porous magnesium structures 10 through a self-assembly process. At this time, the dissolved lithium can react with naphthalene to form lithium naphthalenide. The formed lithium naphthalenide can act as a reducing agent to protect the porous magnesium structure 10 from oxidation.

According to another example, after preparing the porous magnesium structure by dealloying as described above, the step of mixing the prepared porous magnesium structure 10 with a transition metal-containing precursor can be further proceeded. By further proceeding with the above step, a porous magnesium structure further comprising a transition metal can be prepared.

The transition metal-containing precursor may comprise a chloride of the transition metal, a complex of the transition metal, or a combination thereof. The transition metal may include Ni, Ti, Co, or a combination thereof.

A complex of transition metal can be a compound in which the ligand, such as cyclopentadiene, is strongly bonded to the central metal.

The transition metal-containing precursor may be mixed in an amount of 1 part to 10 parts by weight, such as 2 parts to 9 parts by weight, per 100 parts by weight of the porous magnesium structure prepared by dealloying in the previous step. When the transition metal-containing precursor is mixed within the above range, the transition metal can be stably introduced into the porous magnesium structure without leaching, thereby obtaining a porous magnesium structure capable of absorbing and desorbing hydrogen at a faster rate.

A porous magnesium structure further comprising a transition metal, prepared by the method described above, may specifically comprise a magnesium skeleton 11 and pores 12, wherein the transition metal is located on the surface of the magnesium skeleton 11.

The porous magnesium structure according to one example is produced in a solution-phase reaction at room temperature and is therefore easily mass-produced. Furthermore, according to one example, the magnesium-alkali metal alloy can be easily dealloyed by placing it in a solution and stirring it, making the manufacturing method easy and simple.

The following describes a method of storing hydrogen using the porous magnesium structure 10 described above.

The hydrogen storage method according to one example is carried out by absorbing hydrogen within the aforementioned porous magnesium structure 10 and reversibly desorbing it. Specifically, it may be performed by applying hydrogen gas to the porous magnesium structure 10 at a predetermined temperature to absorb hydrogen to obtain magnesium hydride, and then raising the temperature and removing the hydrogen gas to reversibly desorb hydrogen gas from the magnesium hydride.

The absorption of hydrogen gas may be carried out at a temperature of 150° C. to 200° C., such as at a temperature of 160° C. to 190° C. The desorption of hydrogen gas may be performed at a temperature of 250° C. to 300° C., such as at a temperature of 260° C. to 290° C. As rapid absorption and desorption of hydrogen even at low temperatures, such as the above temperature range, can occur, the porous magnesium structure according to one example can be usefully employed as a hydrogen storage material.

The porous magnesium structure according to one example is capable of absorbing and desorbing about 5% of hydrogen, relative to the total weight of the porous magnesium structure, in 40 minutes.

The following examples describe the above examples in more detail. However, the following examples are for illustrative purposes only and are not intended to limit the scope of the claims.

### Manufacturing of Porous Magnesium Structure

### Example 1

A porous magnesium structure was prepared by dealloying a Mg—Li alloy (Mg₁₅Li₈₅, NEBA Corporation) by adding it to 110 mL of a solution in which 0.16 M of naphthalene was dissolved in a tetrahydrofuran (THF) solvent per 100 mg of the above alloy and stirring it.

### Comparative Example 1

A porous magnesium structure was prepared by electrochemically dealloying by placing a Mg—Li alloy foil as a positive electrode and a Li foil as a negative electrode, and applying a 1.5 V voltage thereto. Specifically, upon application of the voltage, Li was selectively removed from the Mg—Li alloy at the positive electrode to produce a porous magnesium structure, and at the negative electrode, the removed Li grew into dendrites.

### Evaluation 1: SEM Analysis

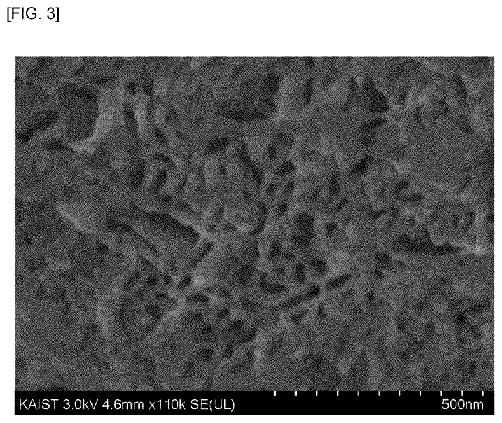

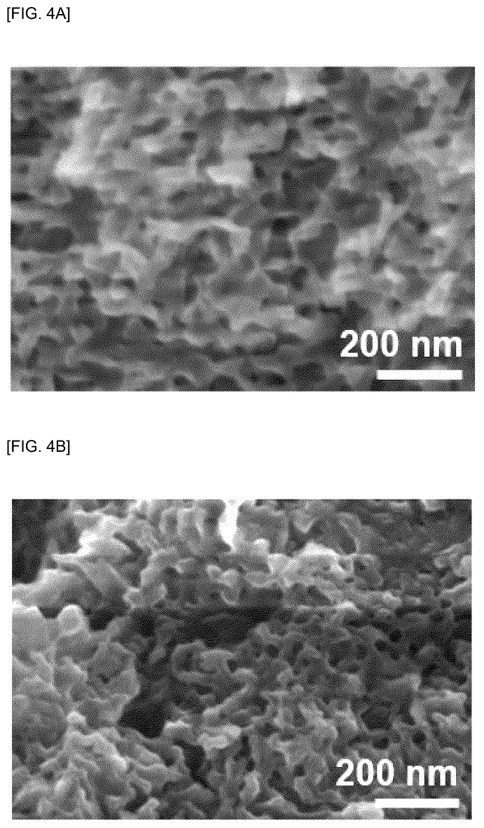

Scanning electron microscopy (SEM) analysis was performed to confirm the structure of the porous magnesium structures according to Example 1 and Comparative Example 1, and the results are shown in FIG. 3 to FIG. 4B.

FIG. 3 is a scanning electron microscope (SEM) image of a porous magnesium structure for storing hydrogen according to Example 1.

Referring to FIG. 3, it can be seen that the porous magnesium structure according to one example comprises a magnesium skeleton and pores, and has a three-dimensional porous structure, wherein the average thickness of the magnesium skeleton is 50 nm or less.

FIG. 4A is an SEM image of a porous magnesium structure for storing hydrogen according to Example 1, and FIG. 4B is an SEM image of a porous magnesium structure for storing hydrogen according to Comparative Example 1.

Referring to FIG. 4A and FIG. 4B, it can be seen that the porous magnesium structure according to Example 1 has both the magnesium skeleton and the pores at the nanoscale, whereas in the case of Comparative Example 1, the pores are very large with sizes outside the nanoscale, and the variation in pore size is also very large.

### Evaluation 2: XRD Analysis

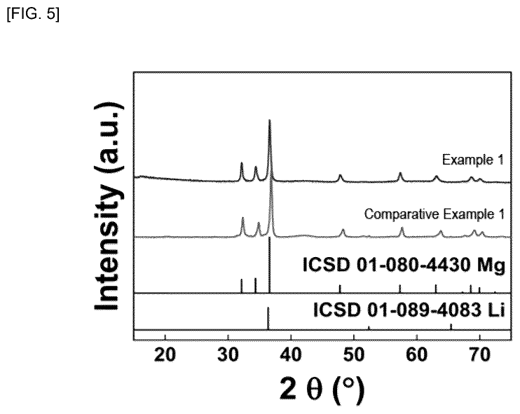

X-ray diffraction (XRD) analysis was performed to confirm the crystal structure of the porous magnesium structures according to Example 1 and Comparative Example 1, and the results are shown in FIG. 5.

FIG. 5 is an XRD analysis graph of porous magnesium structures for storing hydrogen according to Example 1 and Comparative Example 1.

Referring to FIG. 5, it can be seen that the porous magnesium structure according to one example has a diffraction peak at 20 between 35° and 40° in the XRD pattern, indicating that the crystal structure of Mg is well formed.

### Evaluation 3: Specific Surface Area Analysis

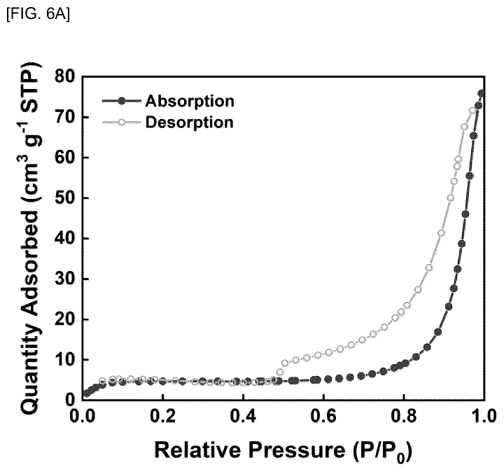

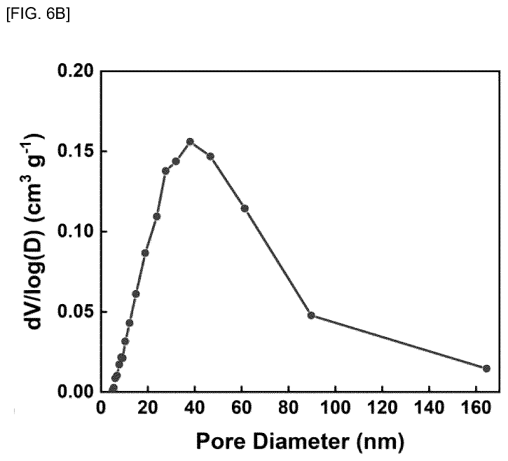

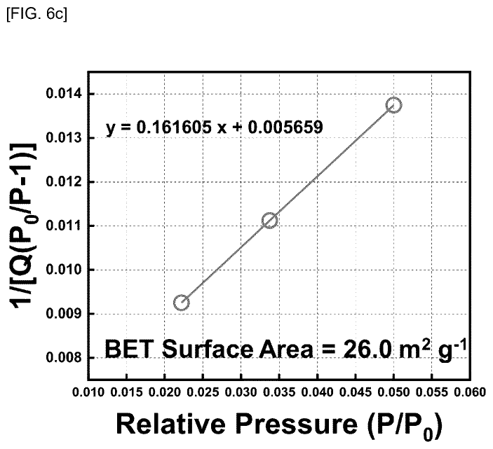

The specific surface area of the porous magnesium structure according to Example 1 was measured by the Brunauer-Emmett-Teller (BET) method, and the results are shown in FIG. 6A to FIG. 6C.

FIG. 6A is an N₂ adsorption curve of a porous magnesium structure for storing hydrogen according to Example 1, FIG. 6B is a pore size distribution curve of a porous magnesium structure for storing hydrogen according to Example 1, and FIG. 6C is a BET analysis graph of a porous magnesium structure for storing hydrogen according to Example 1.

Referring to FIG. 6A to FIG. 6C, it can be seen that the porous magnesium structure according to one example has a specific surface area in the range of 20 m²/g to 40 m²/g, allowing absorption and desorption of hydrogen at a rapid rate and at a low temperature.

### Evaluation 4: XPS Analysis

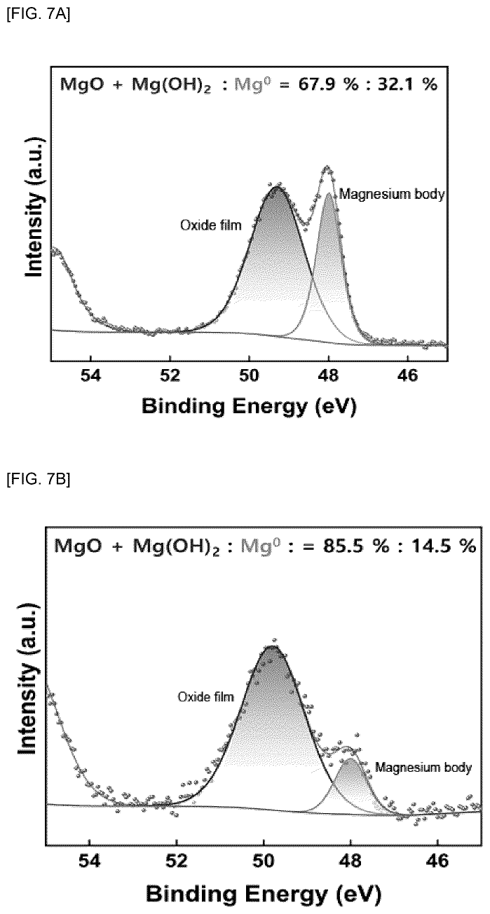

To confirm the oxide film structure in the porous magnesium structures according to Example 1 and Comparative Example 1, X-ray photoelectron spectroscopy (XPS) analysis (Mg 2p XPS) was performed, and the results are shown in FIG. 7A and FIG. 7B.

FIG. 7A is an XPS analysis graph of a porous magnesium structure for storing hydrogen according to Example 1, and FIG. 7B is an XPS analysis graph of a porous magnesium structure for storing hydrogen according to Comparative Example 1.

Referring to FIG. 7A and FIG. 7B, it can be seen that the porous magnesium structure according to one example includes both a magnesium body and an oxide film located on the surface thereof. It can also be seen that in Example 1, the molar ratio of the magnesium body to the oxide film is about 1:2 in a region with a depth of 1 nm to 10 nm from the surface to the interior of the magnesium skeleton, which is within the molar ratio range of 1:1 to 1:5 according to one example. On the other hand, in Comparative Example 1, the molar ratio of the magnesium body and the oxide film is about 1:6. From this, it can be seen that the porous magnesium structure according to one example has a relatively thin oxide film, and it can be expected that the absorption and desorption of hydrogen can occur at a fast rate at a low temperature.

### Evaluation 5: Rate of Absorption and Desorption of Hydrogen

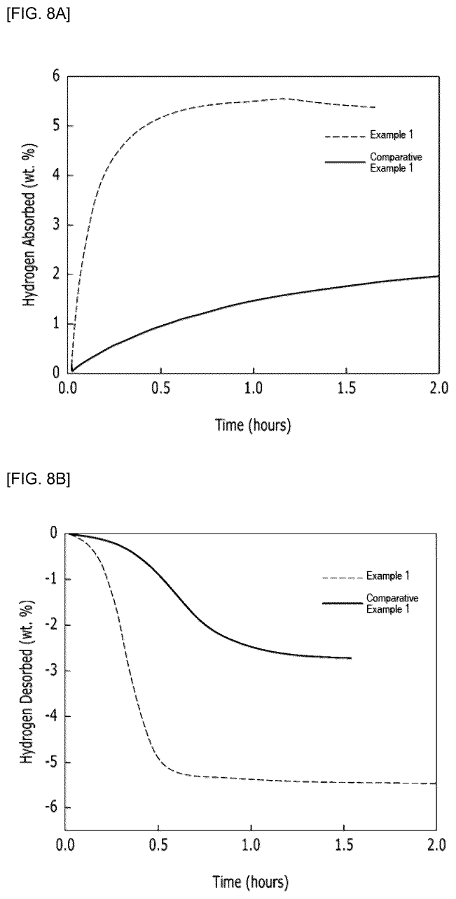

The absorption and desorption rates of hydrogen for the porous magnesium structures according to Example 1 and Comparative Example 1 were determined, and the results are shown in FIG. 8A and FIG. 8B.

The measurement was performed with a Sievert apparatus, which is a pressure/volume-based measurement, the absorption of hydrogen was performed in a hydrogen pressurized environment at 200° C. and 16 bar, and the desorption of hydrogen was performed in a static vacuum environment at 300° C. and 0 bar.

FIG. 8A is a hydrogen uptake curve of porous magnesium structures for storing hydrogen according to Example 1 and Comparative Example 1, and FIG. 8B is a hydrogen desorption curve of porous magnesium structures for storing hydrogen according to Example 1 and Comparative Example 1.

Referring to FIG. 8A and FIG. 8B, it can be seen that the porous magnesium structure according to Example 1 allows both absorption and desorption of hydrogen at a faster rate compared to Comparative Example 1.

Although preferred examples of the present invention have been described in detail above, the scope of the present invention is not limited thereto, and various modifications and improvements by those skilled in the art utilizing the basic concepts of the present invention as defined in the following claims are also within the scope of the present invention.

1. A porous magnesium structure for storing hydrogen containing a magnesium skeleton and pores, and having a three-dimensional porous structure,
wherein the magnesium skeleton has an average thickness of greater than 0 nm and less than or equal to 200 nm.

2. The porous magnesium structure for storing hydrogen of claim 1, wherein the magnesium skeleton comprising a magnesium body and an oxide film located on a surface of the magnesium body.

3. The porous magnesium structure for storing hydrogen of claim 2, wherein the oxide film comprises magnesium oxide, and the magnesium oxide comprises MgO.

4. The porous magnesium structure for storing hydrogen of claim 2, wherein the magnesium body and the oxide film have a molar ratio of 1:1 to 1:5.

5. The porous magnesium structure for storing hydrogen of claim 1, wherein the pores have an average diameter of 20 nm to 200 nm.

6. The porous magnesium structure for storing hydrogen of claim 1, wherein the porous magnesium structure has a specific surface area of 30 m²/g to 40 m²/g.

7. The porous magnesium structure for storing hydrogen of claim 1, wherein the porous magnesium structure has a diffraction peak at 20 of 35° to 40° in the XRD pattern.

8. The porous magnesium structure for storing hydrogen of claim 1, further comprising a transition metal located on the surface of the magnesium skeleton.

9. The porous magnesium structure for storing hydrogen of claim 8, wherein the transition metal comprises a metal having a higher standard reduction potential than magnesium.

10. A method of preparing a porous magnesium structure for storing hydrogen comprising preparing a porous magnesium structure having a magnesium skeleton and pores by dealloying a magnesium-alkali metal alloy in a solution in which an aromatic compound is dissolved in an organic solvent.

11. The method of preparing a porous magnesium structure for storing hydrogen of claim 10, wherein the aromatic compound comprises naphthalene, biphenyl, phenanthrene, anthracene, or a combination thereof.

12. The method of preparing a porous magnesium structure for storing hydrogen of claim 10, wherein the dealloying is performed by dissolving an alkali metal from a magnesium-alkali metal alloy.

13. The method of preparing a porous magnesium structure for storing hydrogen of claim 12, wherein dissolved alkali metal reacts with an aromatic compound in the solution to form a by-product.

14. The method of preparing a porous magnesium structure for storing hydrogen of claim 10, after preparing the porous magnesium structure, further comprising mixing the prepared porous magnesium structure with a transition metal-containing precursor to produce a transition metal-containing porous magnesium structure.

15. The method of preparing a porous magnesium structure for storing hydrogen of claim 14, wherein the transition metal-containing precursor comprises a chloride of a transition metal, a complex of a transition metal, or a combination thereof.

16. The method of preparing a porous magnesium structure for storing hydrogen of claim 14, wherein the transition metal-containing precursor is mixed in an amount of 1 part by weight to 10 parts by weight per 100 parts by weight of the prepared porous magnesium structure.

17. The method of preparing a porous magnesium structure for storing hydrogen of claim 14, wherein, in the transition metal-containing porous magnesium structure is located on a surface of the magnesium skeleton.

18. A method of storing hydrogen comprising:
absorbing hydrogen gas into the hydrogen storage porous magnesium structure according to claim 1 to obtain magnesium hydride; and
reversibly desorbing hydrogen gas from the magnesium hydride.

19. The method of storing hydrogen of claim 18, wherein the absorbing is performed at a temperature of 150° C. to 200° C.

20. The method of storing hydrogen of claim 18, wherein the desorbing is performed at a temperature of 250° C. to 300° C.
